(19) United States
(12) Patent Application Publication
(10) Pub. No.: US 2014/0298285 A1
(43) Pub. Date: Oct. 2, 2014

(54) DESIGN ASSISTANCE DEVICE, DESIGN ASSISTANCE METHOD, AND DESIGN ASSISTANCE PROGRAM

(71) Applicant: FUJITSU LIMITED, Kawasaki-shi (JP)

(72) Inventor: Mitsuru Sato, Kawasaki (JP)

(73) Assignee: FUJITSU LIMITED, Kawasaki-shi (JP)

(21) Appl. No.: 14/179,635

(22) Filed: Feb. 13, 2014

(30) Foreign Application Priority Data
Mar. 29, 2013 (JP) 2013-075354

(51) Int. Cl. G06F 17/50

(52) U.S. Cl. CPC G06F 17/50
USPC 716/136

(57) ABSTRACT

A determination unit determines whether there is error allowance information having the same error identification ID and the same error object as error information, and determines whether error related information is also the same when there is the same error allowance information. As a result, when there is error allowance information having the same error identification ID and the same error object as the error information and different error related information from the error information, the disablement unit disables error allowance.

### CROSS-REFERENCE TO RELATED APPLICATION(S)

This application is based upon and claims the benefit of priority of the prior Japanese Patent Application No. 2013-075354, filed on Mar. 29, 2013, the entire contents of which are incorporated herein by reference.

### FIELD

The embodiment discussed herein is related to a design assistance device, a design assistance method, and a design assistance program.

### BACKGROUND

The development of a printed circuit board is performed through stages including specification design, circuit design, packaging design, an analysis, production of an experimental board, and manufacture. The specification design is a process of determining specifications such as requirements of a system realized by the printed circuit board (functions to be realized, a component configuration, an operation frequency, and a bus configuration) and manufacturing conditions (layout limitation and the number of layers) by a developer. The circuit design is a design process of connecting a plurality of components (an IC, a resistance, a capacitor, and the like) and a power source/ground with a net (line) by the designer in order to realize a function of a system.

The packaging design is a design process of actually making layout/wiring on the board using data created in the circuit design by the designer. The analysis is a process of analyzing whether any problem about manufacturing does not occur using layout data by an analyzer. The production of an experimental board is a process of manufacturing a printed circuit board. An actual device test is performed using the experimental board, and mass production of actual products is started if there is no problem.

At the circuit design stage, a circuit design assistance device that assists circuit design of the designer is used. The circuit design assistance device displays a component arranged by the designer, and stores data of the component in a database. In addition, the circuit design assistance device includes a design rule check (DRC) function. The DRC function is a function to check correctness of a circuit based on design rules.

Check items to be checked by the DRC are broadly classified into a drawing check to point out an error of a notation of a circuit diagram, and a logical check to point out an error of a logical configuration of a circuit. Examples of the drawing check include a cross wire connection check, a check of component layout outside a frame of a drawing, and a check of overlapping of a letter and a component. Examples of the logical check include a check of whether there is no unconnected power source pin, a check of when there is no input pin in a net, or no output pin, and a check of dot logic (where an input pin is driven by a plurality of output pins).

When the DRC is executed, the circuit design assistance device outputs an error of a part that infringes a design rule. Examples of the error to be output include “no connection to an input pin in the net X1”, “no connection to an output pin in the net X2”, and “the component Y1 is arranged outside the frame of the drawing”.

Among the errors to be output, there are an error that needs to be modified by the designer, and an error, which is enough to be warned, and a modification of which by the designer is not indispensable. The content confirmed by the designer that “no problem if not modified” can be held as “error allowance information” by the circuit design assistance device.

An error output unit of the DRC causes an error, which has been allowed by the designer in the past, to be an error not to be output. This enables the designer not to confirm an error that the designer confirmed in the past, and to confirm only necessary errors.

However, there is a case in which appropriateness of the design needs to be confirmed again (error check) as a result of some sort of circuit editing conducted with respect to an object element, an error of which has been allowed. At that time, if the designer forgets to delete information of error allowance, a design error output of the DRC remains not being output. Therefore, there is a risk of missing a design error that needs modification.

There is a conventional technology of, when the designer edits an element (a component or a net), an error of which has been allowed, deleting or disabling appropriate error allowance information and causing an error to be output again when an DRC is executed.

Note that there is a conventional technology of prompting the user to designate a confirmed warning item from among warning items with respect to parts to be confirmed on a circuit diagram, and when conducting a check of the circuit diagram again, comparing a warning item with a past check result, and maintaining the designation of the confirmation by the user with respect to the warning item, the content of which can be considered to be identical to the past check result.

Patent Literature 1: Japanese Patent No. 4941382

Patent Literature 2: Japanese Laid-open Patent Publication No. 2005-71282

However, the conventional technology of disabling error allowance information when the designer edits an element, an error of which has been allowed, has a problem not to properly perform disablement of error allowance.

For example, to avoid a state in which error allowance needs disablement but is not disabled, a state may be caused in which error allowance is forced to be disabled even if editing does not always influence errors. Further, when a plurality of designers performs design in parallel, and databases created by the designers are merged, even if editing performed during the parallel work requires disablement of error allowance information in another database, the error allowance information is not disabled.

### SUMMARY

According to an aspect of an embodiment, a design assistance device capable of setting error allowance with respect to an error output by an error check includes an allowance information storage unit that stores information indicating error allowance has been set as error allowance information in addition to error information; a determination unit that compares error information generated by an error check performed after the setting of error allowance with error allowance information corresponding to the error information to determine whether the error information and the error allowance information are identical; and a disablement unit that disables error allowance regarding the error allowance information determined not to be identical by the determination unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a functional configuration of a circuit design assistance device according to an embodiment;

FIG. 2 is a diagram illustrating a functional configuration of a DRC unit;

FIG. 3 is a diagram illustrating an example of error information about each DRC error stored in an error information DB;

FIG. 4 is a diagram illustrating an example of a net without a reception pin;

FIG. 5 is a diagram illustrating error information stored in the error information DB about a DRC error without a reception pin;

FIG. 6 is a diagram illustrating a breakdown voltage check error of a capacitor;

FIG. 7 is a diagram illustrating error information stored in the error information DB about a breakdown voltage check error of a capacitor;

FIG. 8 is a flowchart illustrating a disablement process of error allowance information;

FIG. 9 is a flowchart illustrating a processing flow of an error output unit; and

FIG. 10 is a diagram illustrating a hardware configuration of a computer that executes a circuit design assistance program.

### DESCRIPTION OF EMBODIMENT(S)

Preferred embodiments of the present invention will be explained with reference to accompanying drawings. Note that the embodiment does not limit the disclosed technology.

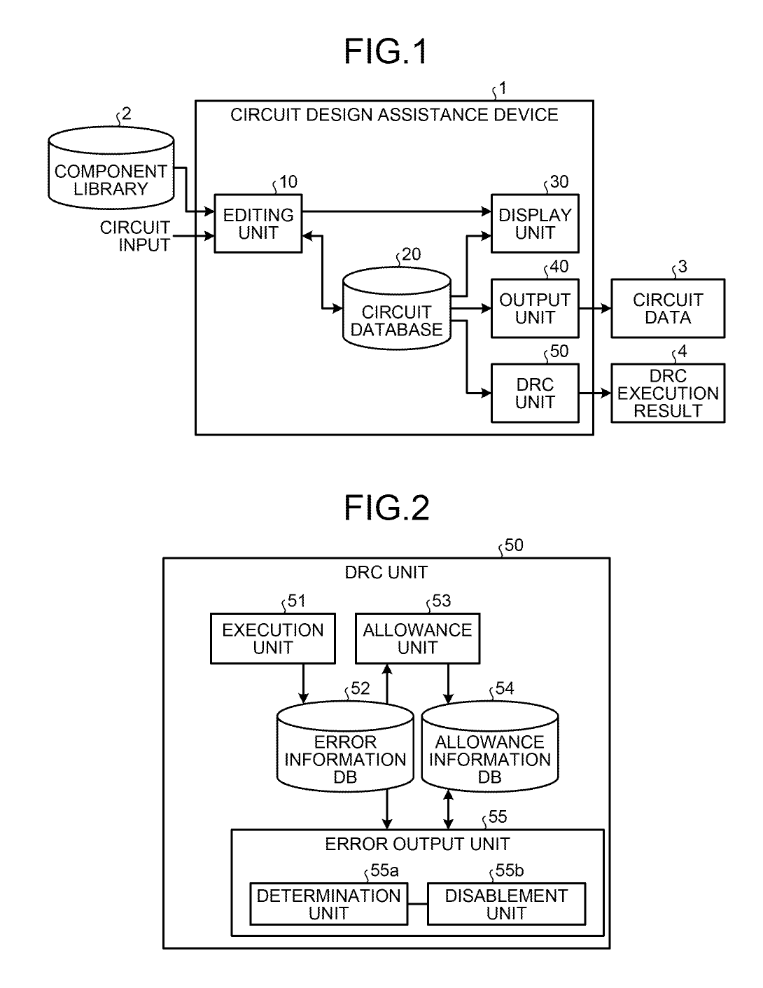

First, a functional configuration of a circuit design assistance device according to the embodiment will be described. FIG. 1 is a block diagram illustrating a functional configuration of a circuit design assistance device according to the embodiment. As illustrated in FIG. 1, a circuit design assistance device 1 includes an editing unit 10, a circuit database 20, a display unit 30, an output unit 40, and a DRC unit 50.

The editing unit 10 receives a circuit input and an editing instruction by a designer, edits the circuit, and stores data of the circuit in the circuit database 20. The designer selects a component to be used from a component library 2, and performs a circuit input. The component library 2 is a library of components used in the circuit. The circuit database 20 stores data of the circuit.

The display unit 30 displays the circuit edited by the editing unit 10 on a display device. The display unit 30 displays the circuit using data in the circuit database 20 on the display device based on an instruction of the designer.

The output unit 40 outputs data related to the designed circuit as circuit data 3. The circuit data 3 includes configuration elements of a printed circuit board such as a component, a power source, a ground, and the like, and connection information thereof. The circuit data 3 is used in the packaging design.

The DRC unit 50 executes a DRC using the data stored in the circuit database 20, and outputs a DRC execution result 4. FIG. 2 is a diagram illustrating a functional configuration of the DRC unit 50. As illustrated in FIG. 2, the DRC unit 50 includes an execution unit 51, an error information DB 52, an allowance unit 53, an allowance information DB 54, and an error output unit 55.

The execution unit 51 executes a DRC, and stores error information about each DRC error in the error information DB 52. The error information DB 52 stores the error information about each DRC error found by the DRC.

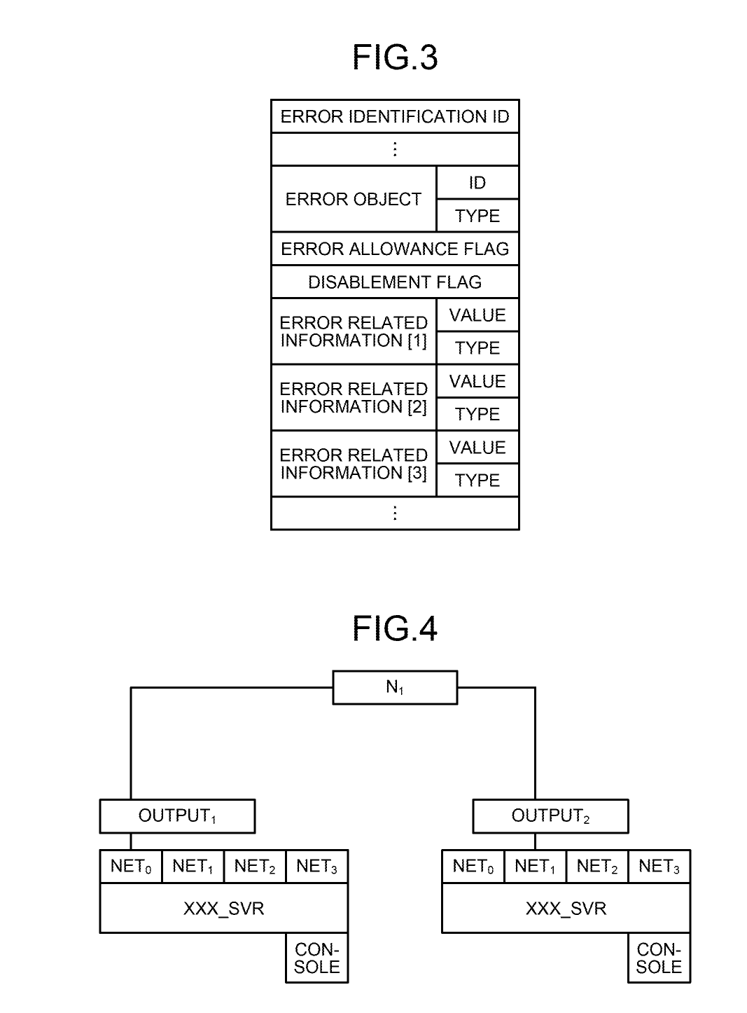

FIG. 3 is a diagram illustrating an example of the error information stored in the error information DB 52 about each DRC error. As illustrated in FIG. 3, the error information DB 52 stores an error identification ID, an error object, an error allowance flag, a disablement flag, and information including an arbitrary pieces of error related information, as the error information.

The error identification ID is an identifier that identifies a type of an error. The error object is an ID (identifier) and a type of an element to be an object of an error. The error allowance flag indicates whether an error has been allowed by the designer. A value of the error allowance flag “ON” indicates an error has been allowed, a value of the error allowance flag “OFF” indicates an error has not been allowed.

The disablement flag indicates whether disabling error allowance regarding an error allowed by the designer. A value of the disablement flag “ON” indicates the error allowance has been disabled, and a value of the disablement flag “OFF” indicates the error allowance has not been disabled. The error related information is information related to an error, and includes a value and a type of the value.

Note that, in the error information stored in the error information DB 52, the error allowance flag and the disablement flag are “OFF”.

The allowance unit 53 sets the error allowance based on an instruction of the designer. To be specific, when the designer designates a DRC error to perform error allowance, the allowance unit 53 reads out corresponding error information from the error information DB 52, and sets a value of the error allowance flag of the read out error information to be “ON”. The allowance unit 53 then stores the error information in which the value of the error allowance flag has been set to be “ON” in the allowance information DB 54 as the error allowance information.

However, when the error allowance information corresponding to the DRC error designated by the designer is already in the allowance information DB 54, the error allowance has been disabled. Therefore, the allowance unit 53 changes the value of the disablement flag of the error allowance information stored in the allowance information DB 54 to be “OFF”.

The allowance information DB 54 stores the error allowance information regarding an error, to which setting of the error allowance has been performed based on an instruction of the designer. The allowance information DB 54 stores, regarding each DRC error, information having the same data structure as the error information stored in the error information DB 52, as error allowance information. Note that, in the error allowance information, the value of the error allowance flag is “ON”.

The error output unit 55 determines whether outputting the error information stored in the error information DB 52 regarding each DRC error as a DRC execution result 4 with reference to the allowance information DB 54, and outputs only the error information that the error output unit 55 has determined to output.

The error output unit 55 includes a determination unit 55a and a disablement unit 55b. The determination unit 55a determines whether outputting the error information stored in the error information DB 52 by each piece of error information. The determination unit 55a determines whether causing the value of the disablement flag of the error allowance information to be “ON”.

To be specific, when error allowance information having an error identification ID and an error object identical to the error information stored in the error information DB 52 is not in the allowance information DB 54, a corresponding DRC error has not been allowed. Therefore, the determination unit 55a determines to output an error.

When error allowance information having an error identification ID, an error object, and related information identical to the error information stored in the error information DB 52 is in the allowance information DB 54, the corresponding DRC error has been allowed. Therefore, the determination unit 55a determines not to output an error.

When error allowance information having an error identification ID and an error object identical to the error information stored in the error information DB 52 and error related information different from the error information is in the allowance information DB 54, the error information has been changed. Therefore, the determination unit 55a determines to output an error. At that time, the determination unit 55a determines to disable the error allowance.

As described above, the determination unit 55a determines to disable the error allowance when error allowance information having an error identification ID and an error object identical to the error information stored in the error information DB 52 and error related information different from the error information is in the allowance information DB 54. Therefore, the DRC unit 50 can properly perform disablement of the error allowance.

The disablement unit 55b changes the value of the disablement flag of the error allowance information to be “ON”, in which the error allowance bas been determined to be disabled by the determination unit 55a, and updates the allowance information DB 54.

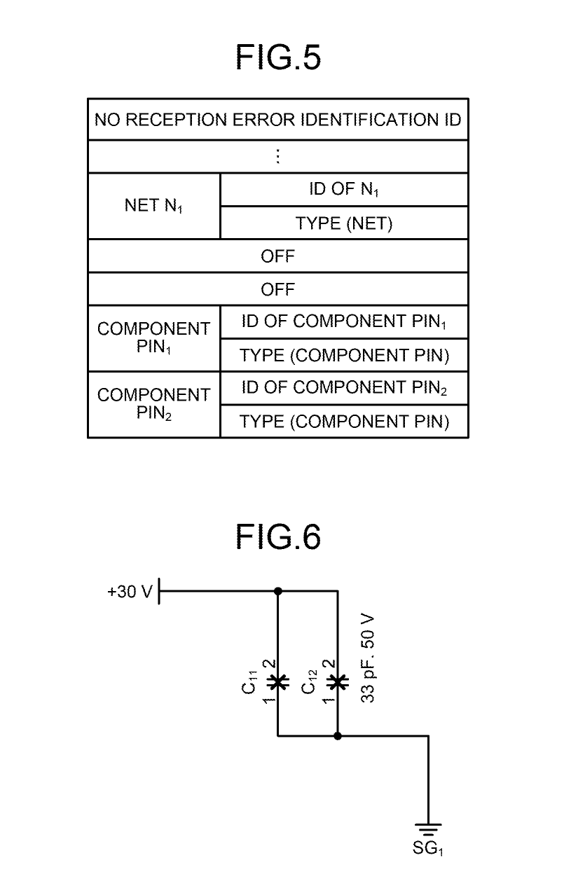

Next, an example of the error information stored in the error information DB 52 will be described using FIGS. 4 to 7. FIG. 4 is a diagram illustrating an example of a net without a reception pin, and FIG. 5 is a diagram illustrating the error information stored in the error information DB 52 regarding a DRC error without a reception pin.

As illustrated in FIG. 4, an output₁ and an output₂ as output pins are connected to a net N₁, but no reception pin is connected thereto. A connection between ICs is established by a connection from a signal output pin to a signal reception pin. Therefore, the net N₁ not including any reception pin has an error, and an error message saying “no reception pin in net N₁” is output.

Further, as illustrated in FIG. 5, the error information includes an identification ID of no reception pin error as the error identification ID, an ID of the net N₁ and a type “net” as the error object, “OFF” as the value of the error allowance flag, and “OFF” as the value of the disablement flag. Further, the error information includes IDs of a connected component pin₁ and component pin₂ and a type “component pin” as the error related information.

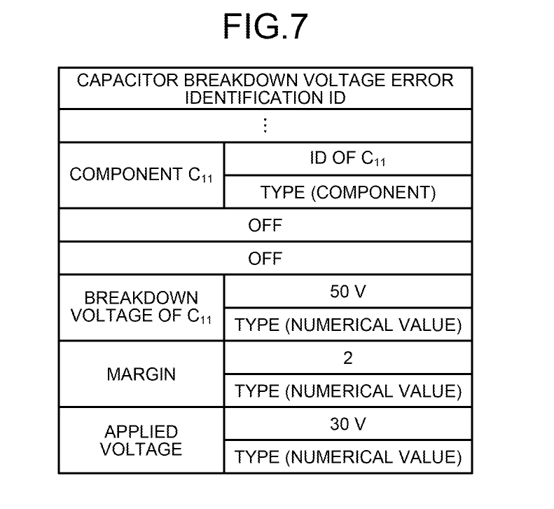

FIG. 6 is a diagram illustrating a breakdown voltage check error of a capacitor, and FIG. 7 is a diagram illustrating the error information stored in the error information DB 52 regarding a breakdown voltage check error of a capacitor. As illustrated in FIG. 6, a breakdown voltage of a capacitor C₁₁ is 50 V, and an applied voltage of the capacitor C₁₁ is 30 V.

When the breakdown voltage or more is applied to a capacitor, the capacitor is determined to have an error by a DRC. In a real check, a margin is taken to some extent. Therefore, the check is performed with an expression: “a breakdown voltage of a capacitor<an applied voltage×a margin”.

For example, when the margin is 2.0 times, “50 V<30 V×2.0” is established with respect to the capacitor C. Therefore, the capacitor C₁₁ has a breakdown voltage error. Therefore, an error message saying excessive applied voltage (50.00 V<30 V×the margin 2.0) is output with respect to the component C₁₁.

Further, as illustrated in FIG. 7, the error information includes an identification ID of a capacitor breakdown voltage error as the error identification ID, an ID of the component C₁₁ and a type “component” as the error object, “OFF” as the value of the error allowance flag, and “OFF” as the value of the disablement flag. Further, the error information includes a value of the breakdown voltage of C₁₁ “50 V” and a type “numerical value”, a value of the margin “2” and a type “numerical value”, and a value of the applied voltage “30 V” and a type “numerical value”, as the error related information.

When the error allowance is performed with respect to the error information illustrated in FIG. 7, the error allowance information in which the error allowance flag “ON” is set is stored in the allowance information DB 54, and when a DRC is performed afterwards, new error information is stored in the error information DB 52. Then, when any of the error related information of the new error information, that is, the breakdown voltage of C₁₁, the margin, or the applied voltage has been changed, the error allowance information in the allowance information DB 54 is disabled.

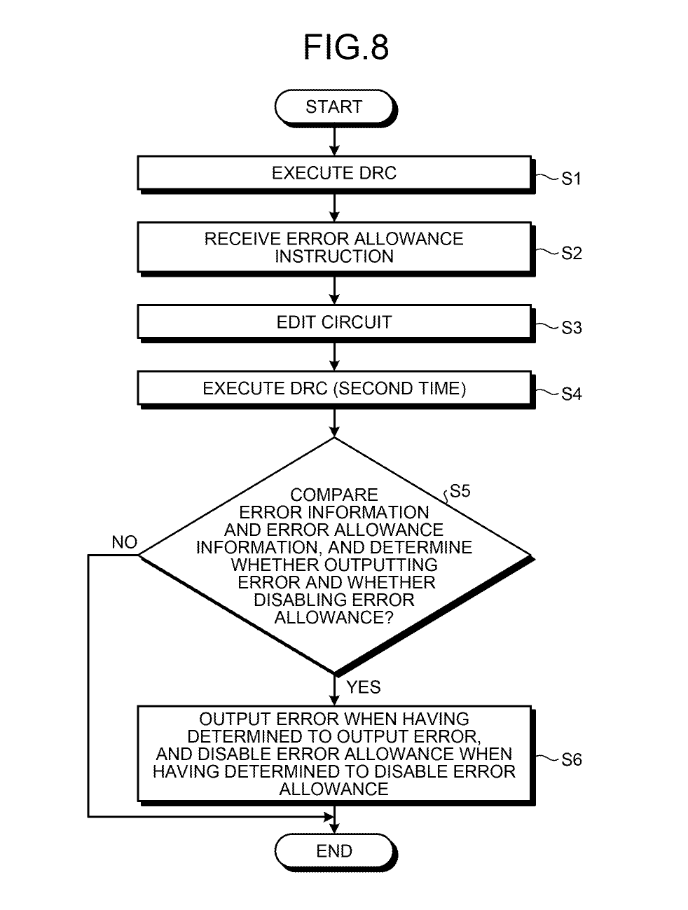

Next, a disablement process of the error allowance information will be described. FIG. 8 is a flowchart illustrating a disablement process of the error allowance information. As illustrated in FIG. 8, the DRC unit 50 executes a DRC (step S1), and outputs a DRC execution result 4. The designer selects an error to be allowed from the DRC execution result 4, and instructs error allowance to the circuit design assistance device 1. The DRC unit 50 receives the error allowance instruction from the designer (step S2).

Following that, the editing unit 10 edits a circuit based on an instruction of the designer (step S3). When the designer instructs a DRC, the DRC unit 50 executes the second DRC (step S4).

The DRC unit 50 then compares error information stored in the error information DB 52 in the second DRC with error allowance information corresponding to the error allowance instruction received in step S2. The DRC unit 50 then determines whether outputting an error and whether disabling the error allowance based on a comparison result (step S5).

When having determined to output an error, the DRC unit 50 outputs an error, and when having determined to disable the error allowance, the DRC unit 50 disables the error allowance (step S6).

As described above, the DRC unit 50 compares the error information with the error allowance information, and determines whether performing an error output and whether disabling the error allowance based on a comparison result, thereby appropriately performing the error output and the disablement of the error allowance.

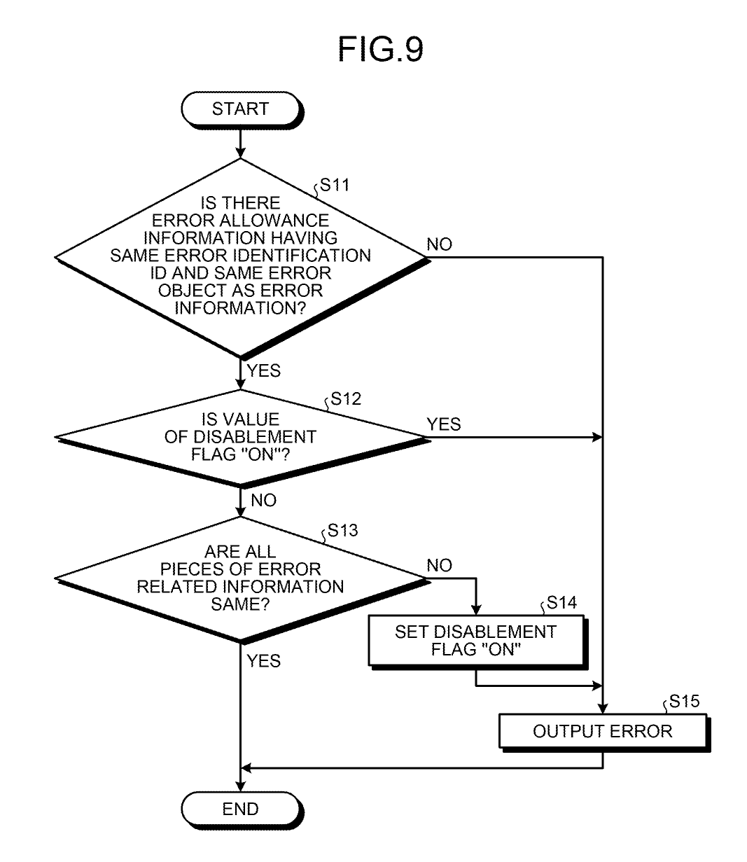

Next, a processing flow of the error output unit 55 will be described. FIG. 9 is a flowchart illustrating a processing flow of the error output unit 55. Note that the processing flow illustrated in FIG. 9 corresponds to the processing of steps S5 and S6 of FIG. 8. In addition, the error output unit 55 performs the processing illustrated in FIG. 9 with respect to each piece of the error information stored in the error information DB 52.

As illustrated in FIG. 9, the error output unit 55 determines whether error allowance information having an error identification ID and an error object identical to the error information is in the allowance information DB 54 (step S11). As a result, when there is the same error allowance information, the error output unit 55 determines whether the value of the disablement flag of the error allowance information is “ON” (step S12), and when the value is not “ON”, the error output unit 55 determines whether all pieces of the error related information are also the same (step S13).

As a result, when all pieces of the error related information are the same, the error is an allowed error. Therefore, the error output unit 55 does not perform an error output, and terminates the processing. Meanwhile, when some pieces of the error related information are not the same, the error output unit 55 sets the disablement flag of the error allowance information to be “ON” (step S14), and outputs an error (step S15).

When error allowance information having an error identification ID and an error object identical to the error information is in the allowance information DB 54, and the value of the disablement flag of the error allowance information is “ON”, the error allowance has been disabled. Therefore, the error output unit 55 outputs an error (step S15). When error allowance information having an error identification ID and an error object identical to the error information is not in the allowance information DB 54, the error information is not an object of error allowance. Therefore, the error output unit 55 outputs an error (step S15).

As described above, when error allowance information having an error identification ID and an error object identical to the error information is in the allowance information DB 54 and some pieces of the error related information are not the same between the error information and the error allowance information, the error output unit 55 disables the error allowance. Therefore, the error output unit 55 can properly perform disablement of the error allowance.

As described above, in the embodiment, the determination unit 55a determines whether there is error allowance information having an error identification ID and an error object identical to the error information, and when there is the same error allowance information, the determination unit 55a determines whether all pieces of the error related information are the same. As a result, when there is error allowance information having an error identification ID and an error object identical to the error information and related information different from the error information, the disablement unit 55b disables the error allowance. Therefore, the circuit design assistance device 1 can properly performs disablement of the error allowance.

In the conventional technology that disables appropriate error allowance information when the designer edits an element, an error of which has been allowed, the developer needs to include processing of disabling error allowance in all edit commands in consideration of an influence of an edit result on a DRC result. Therefore, the work takes an enormous amount of time. Meanwhile, the embodiment needs only improvement of the DRC unit 50, thereby reducing development work.

Note that, in the embodiment, the circuit design assistance device has been described. However, a circuit design assistance program having a similar function can be obtained by realizing the configuration included in the circuit design assistance device by software. A computer that executes the circuit design assistance program will be described.

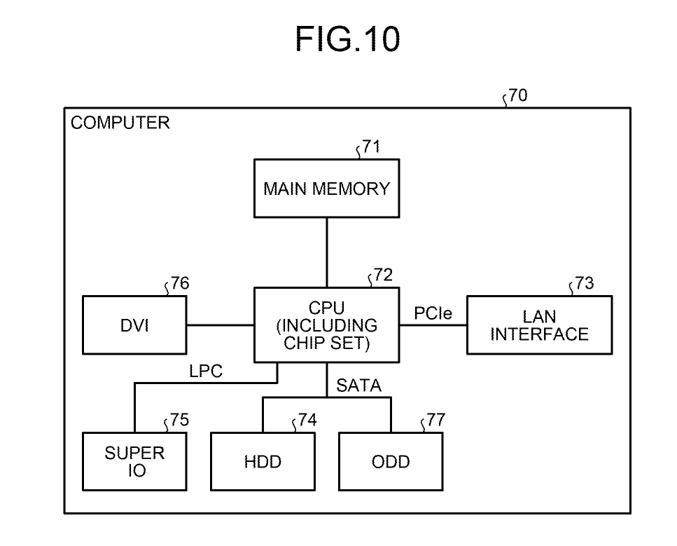

FIG. 10 is a diagram illustrating a hardware configuration of a computer that executes the circuit design assistance program according to the embodiment. As illustrated in FIG. 10, a computer 70 includes a main memory 71, a central processing unit (CPU) 72, a local area network (LAN) interface 73, and a hard disk drive (HDD) 74. Further, the computer 70 includes a super input output (IO) 75, a digital visual interface (DVI) 76, and an optical disk drive (ODD) 77.

The main memory 71 is a memory that stores a program, a result in the middle of execution of the program, and the like. The CPU 72 is a central processing unit that reads out a program from the main memory 71 and executes the program. The CPU 72 includes a chip set including a memory controller.

The LAN interface 73 is an interface for connecting the computer 70 with other computers through a LAN. The HDD 74 is a disk device that stores a program and data, and the super IO 75 is an interface for connecting an input device such as a mouse and a keyboard. The DVI 76 is an interface that connects a liquid crystal display device, and the ODD 77 is a device that performs reading/writing of a DVD.

The LAN interface 73 is connected with the CPU 72 with a PCI express (PCIe), and the HDD 74 and the ODD 77 are connected with the CPU 72 with serial advanced technology attachment (SATA). The super IO 75 is connected with the CPU 72 with low pin count (LPC).

The circuit design assistance program executed in the computer 70 is stored in a DVD, and is read out from the DVD by the ODD 77 and installed into the computer 70. Alternatively, the circuit design assistance program is stored in a database of another computer system connected through the LAN interface 73, and is read out from the database and installed into the computer 70. The installed circuit design assistance program is then stored in the HDD 74, is read out to the main memory 71, and is executed by the CPU 72.

While, in the embodiment, the circuit design assistance device has been described, the present invention is not limited to the device, and can be similarly applied to a case of assisting design of an object other than circuits. That is, the present invention can be applied to any design assistance device provided with a function to check whether a design result is correct and to set error allowance.

According to an embodiment, disablement of error allowance can be properly performed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A design assistance device capable of setting error allowance with respect to an error output by an error check, comprising:
a storage unit that stores information indicating error allowance has been set as error allowance information in addition to error information;
a determination unit that compares error information generated by an error check performed after the setting of error allowance with error allowance information corresponding to the error information to determine whether the error information and the error allowance information are identical; and
a disablement unit that disables error allowance regarding the error allowance information determined not to be identical by the determination unit.

2. The design assistance device according to claim 1, further comprising:
an error output unit that outputs an error based on the error information when the error information and the error allowance information corresponding to the error information are determined not to be identical by the determination unit, and that does not output an error based on the error information when the error information and the error allowance information corresponding to the error information are determined to be identical by the determination unit.

3. The design assistance device according to claim 1, wherein the storage unit stores a type of an error, an object of the error, and related information, as the error information, and
when the type of an error and the object of the error are identical and the related information is different, the determination unit determines the error information and the error allowance information corresponding to the error information are not identical.

4. The design assistance device according to claim 3, wherein, when the storage unit stores the error information regarding a net of a circuit, the storage unit stores information of a pin to be connected to the net, as the related information, and
when the type of an error and the object of the error are identical and the information of a pin is different, the determination unit determines the error information and the error allowance information corresponding to the error information are not identical.

5. The design assistance device according to claim 3, wherein, when the storage unit stores the error information related to a breakdown voltage error regarding a component of a circuit, the storage unit stores at least one of a breakdown voltage of the component, a margin of the breakdown voltage, and an applied voltage, as the related information, and
when the type of an error and the object of the error are identical and at least one of the breakdown voltage of the component, the margin of the breakdown voltage, and the applied voltage is different, the determination unit determines the error information and the error allowance information corresponding to the error information are not identical.

6. A design assistance device capable of setting error allowance with respect to an error output by an error check, the design assistance device comprising:
a processor configured to execute a process, the process comprising:
comparing error information generated by an error check performed after setting of error allowance with an error allowance information corresponding to an error information to determine whether the error information and the error allowance information are identical; and
disabling error allowance regarding the error allowance information determined not to be identical.

7. A design assistance method executed by a design assistance device capable of setting error allowance with respect to an error output by an error check, the method comprising:
comparing error information generated by an error check performed after setting of error allowance with an error allowance information corresponding to an error information to determine whether the error information and the error allowance information are identical; and
disabling error allowance regarding the error allowance information determined not to be identical.

8. A non-transitory computer-readable storage medium having stored therein a design assistance program capable of setting error allowance with respect to an error output by an error check, the program causing a computer to execute a process comprising:
comparing error information generated by an error check performed after setting of error allowance with an error allowance information corresponding to an error information to determine whether the error information and the error allowance information are identical; and
disabling error allowance regarding the error allowance information determined not to be identical.
